(19) United States
(12) Patent Application Publication
(10) Pub. No.: US 2026/0277697 A1
(43) Pub. Date: Sep. 17, 2026

(54) Cross-Project Connection Sharing

(71) Applicant: Oracle International Corporation, Redwood Shores, CA (US)

(72) Inventors: Avishek Gupta, Kolkata (IN); Neeharika Arunkumar, Bangalore (IN); Ansuman Padhy, Bengaluru (IN); Arif Ahmed Rafique, Parker, CO (US)

(73) Assignee: Oracle International Corporation, Redwood Shores, CA (US)

(21) Appl. No.: 19/080,184

(22) Filed: Mar. 14, 2025

(51) Int. Cl. G06F 9/50

(52) U.S. Cl. CPC G06F 9/5055

(57) ABSTRACT

Techniques for managing connections and connection configurations to be used by resource consumers are disclosed. A system receives a request for a connection configuration to be used by a resource consumer to access a connection to an application resource. The system identifies a set of connection configurations that can be used to connect to the application resource. These connection configurations are stored remotely from the resource consumer. The system presents the identified set of connection configurations for accessing the application resource. The system receives a selection of one of the presented connection configurations. The system configures the resource consumer to use the selected connection configuration to access the connection to the application resource by storing a reference to the connection configuration with the reference being associated with the resource consumer.

### TECHNICAL FIELD

The present disclosure relates to the use of resources in a computing environment. In particular, the present disclosure relates to sharing connections as resources.

### BACKGROUND

In modern computing environments, integration platforms serve as middleware that facilitates communication and data exchange between disparate systems, applications, and services. These platforms operate within on-premise, cloud, or hybrid infrastructures to enable seamless interoperability across diverse technologies. Integration platforms typically consist of tools and services for connecting APIs, transforming data formats, and orchestrating workflows across connected systems.

Integration workflows may be built from components that handle various tasks, such as data transformation, routing, and error handling. These workflows are executed in runtime environments that coordinate interactions between systems and manage the movement of data according to pre-defined logic. Connections are established using standardized protocols, like REST (Representational State Transfer), SOAP (Simple Object Access Protocol), and message queues, while authentication mechanisms, such as OAuth or API (Application Programing Interface) keys, secure access to external systems.

Resource allocation within an integration platform is managed dynamically, ensuring optimal performance and scalability based on workload demands. Containers or isolated execution environments are often employed to encapsulate workflows, configurations, and resources. These environments enable developers to create, test, and deploy integrations without interfering with other processes.

Monitoring and logging tools are integrated into these platforms to provide visibility into execution performance, errors, and system interactions. This telemetry data supports operational oversight, debugging, and optimization of integration workflows. Security protocols, including data encryption and access controls, are applied across multiple layers to ensure the confidentiality and integrity of data in transit and at rest.

Governance mechanisms are incorporated into integration platforms to maintain control over connections, workflows, and their associated configurations. Metadata about system interactions and execution states is stored for auditability and change management. By combining these capabilities, integration platforms offer a standardized framework for connecting systems and automating processes across complex computing landscapes.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for connection sharing in accordance with one or more embodiments;

FIG. 3 illustrates a connection management system configuring two resource consumers in one or more embodiments; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CONNECTION SHARING ARCHITECTURE
3. CROSS-PROJECT CONNECTION SHARING
4. COMPUTER NETWORKS AND CLOUD NETWORKS
5. HARDWARE OVERVIEW
6. MISCELLANEOUS; EXTENSIONS

### GENERAL OVERVIEW

One or more embodiments manage and present connection configurations to be used by resource consumers to access connections to application resources. A connection is a coupling between a connection configuration and an application resource that can be accessed via the connection configuration. A system initially stores connection configurations remotely from resource consumers that use the connection configurations to access connections to application resources. When a system receives a request for a connection configuration to be used by a resource consumer to access a connection to an application resource, the system identifies a candidate set of connection configurations that can be used to connect to the application resource. The candidate set of connection configurations may be based, for example, on a connection type specified by the request and/or characteristics of the resource consumer. The system presents the candidate set of connection configurations for accessing the application resource. The system receives a selection of one of the presented connection configurations. The system configures the resource consumer to use the selected connection configuration to access the connection to the application resource. The system configures the resource consumer by storing a reference to the connection configuration with the reference being associated with the resource consumer.

One or more embodiments described in this Specification and/or recited in the claims may not be included in this General Overview section.

### CONNECTION SHARING ARCHITECTURE

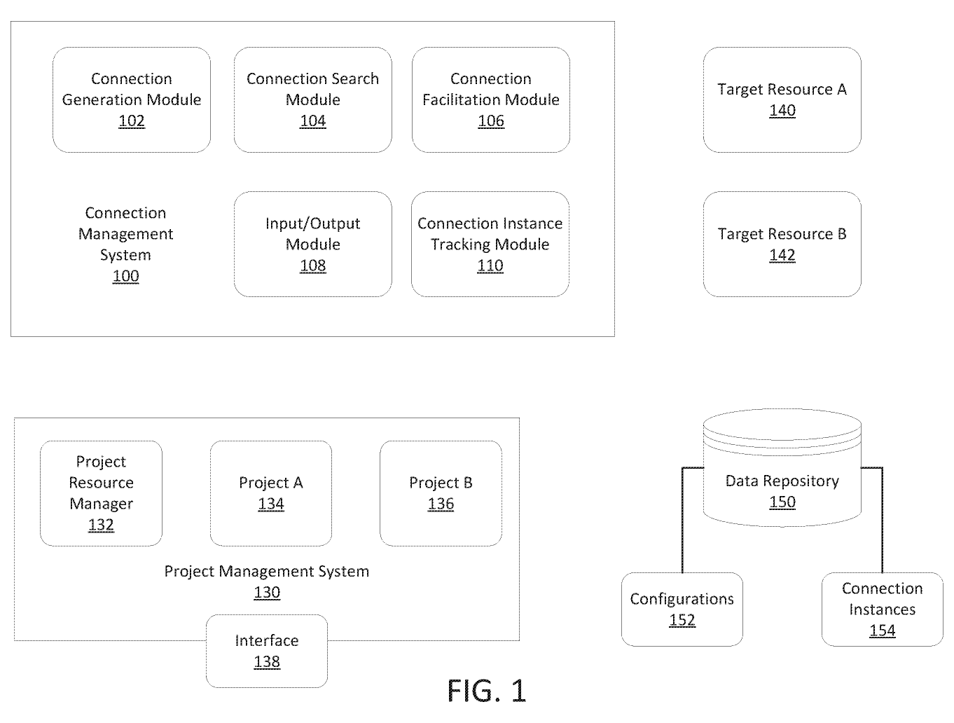

FIG. 1 illustrates a connection management system 100 in accordance with one or more embodiments. As illustrated in FIG. 1, connection management system 100 includes connection generation module 102, connection search module 104, connection facilitation module 106, input/output module 108, and connection instance tracking module 110. FIG. 1 further illustrates project management system 130. Project management system 130 includes project resource manager 132, project A 134, project B 136, and interface 138. FIG. 1 further illustrates target resource A 140, target resource B 142, and data repository 150. Data repository 150 includes configurations 152 and connection instances 154. In one or more embodiments, the connection management system 100 and other systems and resources illustrated in FIG. 1 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In an embodiment, connection management system 100 is configured to facilitate the creation, retrieval, deployment, and monitoring of connections for integration workflows. Connection management system 100 interacts with resource consumers, connection configurations, and application resources to establish and manage couplings that enable data exchange and process automation. The system coordinates the interactions between connection generation module 102, connection search module 104, and other modules for efficient and secure operation of connections across projects.

In an embodiment, connection generation module 102 is configured to create connections by linking connection configurations with application resources. Resource consumers provide details for the connection configuration, such as endpoint identifiers and authentication credentials, that are processed by connection generation module 102. This module validates the provided parameters and establishes the connection by associating the connection configuration with the application resource. The connection is stored in data repository 150, making it available for deployment by resource consumers in various projects.

In an embodiment, connection generation module 102 ensures that the created connection adheres to operational requirements defined by resource consumers. The module validates endpoint compatibility, verifies authentication credentials, and tests the connection’s ability to access the specified application resource. Upon successful validation, the connection is made available in the context of the requesting project or resource consumer. In an embodiment, connection generation module 102 supports the modification of existing connections to accommodate changes in connection configurations or application resources. Resource consumers can update parameters, such as endpoints or credentials, and connection generation module 102 applies these updates while maintaining the association with the application resource. The modified connection is stored in data repository 150 for subsequent workflows and projects to utilize the updated configuration without requiring manual adjustments.

In an embodiment, connection search module 104 is configured to enable resource consumers to locate and retrieve existing connections stored in data repository 150. Resource consumers can specify search criteria, such as endpoint identifiers, application resource types, or project associations, to filter the available connections. Connection search module 104 processes the search query and retrieves connections that meet the specified criteria. Resource consumers can use the retrieved list of connections to select a connection for their workflows.

In an embodiment, connection search module 104 provides advanced filtering capabilities to refine search results based on various attributes, such as protocol type, authentication method, or usage frequency. By leveraging metadata stored alongside connections in data repository 150, resource consumers can efficiently identify connections that match the technical requirements of their integration workflows. For complex integration environments, the connection search module takes into consideration other attributes of the project or resource consumer. For example, the search results may highlight suggested connections to use based on a prediction associated with a service used by a project that is missing a required connection.

In an embodiment, connection search module 104 enforces access control policies that restrict resource consumers to viewing and retrieving connections they are authorized to access. Permissions are defined based on roles, projects, or organizational policies and are applied during the query processing stage. Connection search module 104 verifies that retrieved connections align with the resource consumer’s permissions to safeguard sensitive connection configurations and maintain security.

In an embodiment, connection search module 104 supports auditing of search activities and retrieval actions performed by resource consumers. The module records metadata about search queries, retrieved connections, and access timestamps in data repository 150. This audit data is accessible to administrators for monitoring usage patterns, enforcing compliance with organizational policies, and identifying unauthorized activities. Connection search module 104 supports governance and accountability by providing detailed visibility into connection search operations. Advanced reporting functionality or a graphical user interface (GUI) for viewing search activity may be configured within connection search module 104.

In an embodiment, connection facilitation module 106 is configured to manage the activation and deployment of connections in integration workflows. When a resource consumer selects a connection for use, connection facilitation module 106 retrieves the connection from data repository 150 and initiates the process of linking the connection configuration to the relevant application resource. For example, connection facilitation module may configure runtime parameters and establishing communication channels between the resource consumer’s project and the target application resource.

In an embodiment, connection facilitation module 106 determines if the deployment of connections adheres to defined security and resource allocation policies. The module coordinates with project management system 130 to allocate necessary resources, such as processing capacity and network bandwidth, to support the connection’s operation. Connection facilitation module 106 also applies encryption and authentication mechanisms defined in the connection configuration to secure data exchanged between the project and the application resource.

In an embodiment, connection facilitation module 106 supports dynamic scaling and fault tolerance for active connections. Based on the performance metrics collected by connection instance tracking module 110, connection facilitation module 106 adjusts resource allocations or reroutes data to maintain stable operation of the connection. This may involve redistributing workloads across alternative application resources or modifying runtime configurations to accommodate changes in the integration environment. These adjustments are executed without requiring manual intervention from the resource consumer.

In an embodiment, connection facilitation module 106 records operational metadata for active connections and updates data repository 150 to reflect the current status of deployed connections. This metadata may include information, such as connection uptime, data throughput, and error rates. The recorded data is made accessible to resource consumers through interface 138, allowing for real-time monitoring and troubleshooting of connections. Connection facilitation module 106 maintains detailed records of connection operations to support optimization and auditing efforts across integration workflows.

In an embodiment, input/output module 108 is configured to handle data exchange between resource consumers’ projects and application resources accessed via connections. Input/output module 108 transmits data according to the connection configuration that defines the endpoint, protocol, and authentication parameters. This module manages the initiation of communication channels and handles the flow of data packets to and from the application resource, adhering to the specified transformation and routing rules.

In an embodiment, input/output module 108 applies data transformation rules defined within the connection configuration for compatibility between the resource consumer’s project and the application resource. These transformations may include format conversions, field mappings, or data encryption, depending on the requirements of the connection. The module processes data packets in both directions, transforming outbound data before it reaches the application resource and transforming inbound data before delivering it to the resource consumer or project.

In an embodiment, input/output module 108 monitors the integrity and performance of data exchange operations. The module tracks various metrics, such as latency, throughput, and error rates, during active connections and logs this data in data repository 150. Input/output module 108 also incorporates retry mechanisms and fallback procedures to address transient communication failures, ensuring that data exchange remains reliable. The logged performance data is accessible through interface 138, providing resource consumers with visibility into the operational status of their integrations.

In an embodiment, connection instance tracking module 110 is configured to monitor the operational state of active connections and collect performance metrics during their usage. This module tracks several parameters, such as connection uptime, data throughput, error occurrences, and latency. The collected data is logged in data repository 150 and associated with the relevant connection entry, providing a record of connection behavior across integration workflows. Connection instance tracking module 110 supports real-time status updates for active connections. These updates are communicated to interface 138, allowing resource consumers and administrators to monitor the health of connections during their operation. Status updates may include information about successful data transmissions, failures, or any anomalies detected in the connection. By providing visibility into real-time operations, connection instance tracking module 110 enables timely identification and resolution of issues.

In an embodiment, connection instance tracking module 110 enforces logging and auditing mechanisms to support governance and compliance requirements. The module records detailed metadata for connection usage events, including timestamps, the identity of the resource consumer, and the specific application resource accessed. This metadata is stored securely in data repository 150 and made accessible for auditing purposes.

In an embodiment, connection instance tracking module 110 provides analytics and reporting capabilities by aggregating and analyzing historical data on connection performance. This analysis includes identifying trends, such as recurring errors, patterns in data throughput, or changes in latency over time. The results of these analyses are made available through interface 138, enabling resource consumers and administrators to optimize connection configurations, enhance reliability, and improve the efficiency of integration workflows.

In an embodiment, project management system 130 is configured to enable resource consumers to create new projects and assign connections to those projects for use in integration workflows. Through project management system 130, resource consumers define project parameters, such as project-specific resources, connection requirements, and access permissions. The system facilitates the association of connections stored in data repository 150 with projects, such as project A 134 and project B 136. By leveraging metadata from connection configurations and existing connections, project management system 130 helps resource consumers to assign appropriate connections to projects without duplication or conflict. Project management system 130 enforces isolation between projects while enabling shared access to connections, ensuring that workflows within project A 134 and project B 136 operate independently but remain compatible with shared connection resources. Resource allocation, usage tracking, and permissions enforcement are coordinated through project management system 130, ensuring integration workflow management across multiple projects.

In an embodiment, project resource manager 132 is configured to handle the allocation and management of resources required for projects, such as project A 134 and project B 136. The project resource manager 132 is configured to manage resources, so projects receive sufficient computational, storage, and network resources to support assigned connections and associated workflows. This allocation process considers the specific requirements of connections, including endpoint configurations and data transfer needs, and adjusts resource assignments dynamically to meet changing workload demands. In an embodiment, project resource manager 132 interacts with connection facilitation module 106 to manage the deployment of connections within projects. When a connection is assigned to project A 134 or project B 136, project resource manager 132 provisions the necessary runtime environment, configures the connection parameters, and coordinates communication with the associated application resource.

In an embodiment, project resource manager 132 enforces access control policies for projects and their connections. These policies define the resource consumers that are authorized to interact with project A 134 and project B 136 and specify the level of access granted to the connections. The project resource manager 132 applies policies to prevent unauthorized access to sensitive connections or project resources. In an embodiment, project resource manager 132 monitors the utilization of connections and resources within projects. The module tracks metrics, such as data throughput, connection usage frequency, and resource consumption, for project A 134 and project B 136. This data is logged in data repository 150 and is made accessible through interface 138, enabling resource consumers to optimize workflows and resource allocations based on actual usage patterns.

In an embodiment, project resource manager 132 supports the modification of project configurations, including the reassignment of connections and adjustments to resource allocations. Resource consumers can add or remove connections from project A 134 or project B 136, update project parameters, or adjust permissions. Project resource manager 132 applies these changes dynamically, ensuring that the project environment remains operational while accommodating the updated configuration. In an embodiment, project resource manager 132 integrates with connection instance tracking module 110 to provide comprehensive monitoring and governance for project operations. By combining real-time tracking of connection performance with project-specific resource management, project resource manager 132 enables resource consumers to maintain integration workflows in project A 134 and project B 136.

In an embodiment, interface 138 is configured to provide resource consumers with a user interface for interacting with project management system 130. Interface 138 enables users to create and manage projects, assign connections, and configure project-specific settings. The interface displays available connections from data repository 150, allowing resource consumers to select and assign connections to projects, such as project A 134 and project B 136. Interface 138 also provides tools for defining project parameters, monitoring usage metrics, and applying access control policies. In an embodiment, interface 138 presents real-time status updates and analytics for projects and connections. Resource consumers can view operational metrics, such as connection performance and resource utilization, through graphical and tabular representations. Interface 138 also facilitates auditing and troubleshooting by providing access to logs and historical data stored in data repository 150. By integrating these capabilities, interface 138 serves as the primary tool for managing integration workflows and maintaining visibility into the operations of project management system 130.

In an embodiment, target resource A 140 and target resource B 142 represent external systems or services accessed via connections established through connection management system 100. These target resources are coupled to connection configurations that define the endpoints, protocols, and authentication credentials required for communication. Through projects, such as project A 134 and project B 136, the connections enable resource consumers to perform operations, such as data retrieval, updates, or processing tasks, on these target resources. The interactions between target resources and projects are governed by the parameters defined in the connection configurations.

In an embodiment, target resource A 140 and target resource B 142 are integrated with the input/output module 108 to facilitate data exchange with project workflows. Data transformation rules applied by the input/output module 108 for compatibility between the formats used by the projects and those required by the target resources. The resources are accessed dynamically during workflow execution, allowing projects to interact with application resources in real time. These target resources may serve different operational purposes, such as providing business data, enabling third-party services, or hosting critical applications, and are managed to maintain seamless integration across diverse workflows. Connection instance tracking module 110 logs performance metrics and operational details for connections to target resource A 140 and target resource B 142.

In one or more embodiments, a data repository 150 is any type of storage unit and/or device (e.g., a file system, database, collection of tables, or any other storage mechanism) for storing data. Furthermore, a data repository 150 may include multiple different storage units and/or devices. The multiple different storage units and/or devices may or may not be of the same type or located at the same physical site. Furthermore, a data repository 150 may be implemented or executed on the same computing system as connection management system 100. Additionally, or alternatively, a data repository 150 may be implemented or executed on a computing system separate from connection management system 100. The data repository 150 may be communicatively coupled to connection management system 100 via a direct connection or via a network.

In an embodiment, data repository 150 is configured to store and manage configurations, connection instances, and associated metadata required for the operation of connection management system 100. This database acts as a centralized repository, ensuring that stored data is accessible to different modules, such as connection generation module 102, connection search module 104, and connection instance tracking module 110. Data repository 150 organizes configurations 152 that define connection parameters, such as endpoints and credentials, alongside connection instances 154 that capture the details of active and historical assignments of connections to projects to support retrieval, updating, and auditing of data related to integration workflows.

In an embodiment, data repository 150 supports indexing and metadata tagging to optimize the retrieval and management of stored data. Metadata associated with configurations 152 and connection instances 154 may include timestamps, user identifiers, project associations, and performance metrics. These metadata attributes enhance search capabilities and enable fine-grained control over data access and updates. The data repository also supports transactional integrity, ensuring that changes to configurations or connection instances are recorded consistently to maintain reliability and accuracy in integration workflows.

In an embodiment, configurations 152 represent the stored parameters and settings required to establish connections. These configurations include numerous details, such as endpoint addresses, authentication credentials, protocol specifications, and data transformation rules. Configurations 152 are created by connection generation module 102 and stored in data repository 150, where they remain accessible for assignment to projects, such as project A 134 and project B 136. By providing a repository for connection configurations, configurations 152 facilitate efficient reuse of connection settings across multiple workflows and projects.

In an embodiment, configurations 152 are augmented with metadata that provides additional context about the stored configurations. Metadata attributes may include creation and modification timestamps, the identity of the resource consumer who defined the configuration, and versioning information. This metadata supports governance and compliance by enabling resource consumers and administrators to track changes to connection configurations and ensure that they align with organizational policies. The metadata also enhances search and retrieval functionality within connection search module 104, allowing users to locate configurations that meet specific technical or operational criteria.

In an embodiment, connection instances 154 represent the association of specific connections with projects, such as project A 134 and project B 136. Connection instances capture details about the connection’s usage, including the assigned project, the target resource being accessed, and the status of the connection. Connection instances 154 are created and updated by modules, such as connection facilitation module 106 and connection instance tracking module 110, ensuring that the database reflects the current state of connections deployed within the system.

In an embodiment, connection instances 154 are enriched with metadata that provides a historical and operational view of connection usage. Metadata may include timestamps for activation and deactivation, performance metrics, such as data throughput and error rates, and audit logs detailing user interactions with the connection. This metadata is stored in data repository 150 alongside the connection instances, enabling detailed monitoring, reporting, and optimization of connection operations. Connection search module 104 and interface 138 utilize this information to provide resource consumers with visibility into connection assignments and usage patterns.

Information describing configurations 152 and connection instances may be implemented across any of components within the system 100. However, this information is illustrated within the data repository 150 for purposes of clarity and explanation.

Additional embodiments and/or examples relating to computer networks are described below in Section 4, titled “Computer Networks and Cloud Networks.”

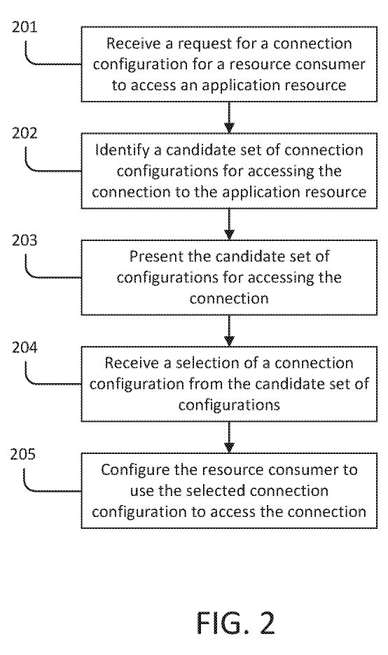

In one or more embodiments, connection management system 100 refers to hardware and/or software configured to perform operations described herein for cross-project connection sharing. Examples of operations for cross-project connection sharing are described below with reference to FIG. 2.

In an embodiment, connection management system 100 and other systems described in connection with FIG. 1 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, interface 138 refers to hardware and/or software configured to facilitate communications between a user and project management system 130. Interface 138 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 138 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 138 is specified in one or more other languages, such as Java, C, or C++.

### CROSS-PROJECT CONNECTION SHARING

FIG. 2 illustrates an example set of operations for cross-project connection sharing in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system receives a request for a connection configuration for a resource consumer to access an application resource (Operation 201). The request specifies various details, such as the target application resource, the intended type of connection, and the specific operational requirements, including authentication protocols and endpoint configurations. For example, the resource consumer might request a connection configuration to integrate with a third-party CRM system or a cloud-based storage service. The system processes the incoming request by identifying the required parameters for the connection, such as connection type (e.g., Oracle Database, Salesforce), supported communication protocols (e.g., REST, SOAP) or credential types (e.g., OAuth, API keys). The request may also include advanced options, such as the need for data transformation or monitoring capabilities. The system checks the request against predefined templates or patterns to determine if it aligns with existing standards or requires customization. Request details are logged in content item database 150 for traceability and governance, ensuring that the request can be reviewed or audited later.

In an embodiment, the system parses the request to identify the application resource, examining different attributes, such as its endpoint address, expected data structure, and any special connection requirements. For example, if the target is an external API, the system extracts the base URL, required authentication method, and supported operations. The system verifies that sufficient information is provided to proceed with identifying a connection configuration or generating a new one. If any key attributes are missing, the system may prompt the resource consumer through interface 138 to supply additional details. The request may also indicate specific projects, such as project A 134 or project B 136, that will use the connection. The system is configured to associate the configuration with the correct operational context. Metadata from the request, such as timestamps and the identity of the resource consumer, is stored alongside the request details.

In an embodiment, the system validates the request parameters to confirm their alignment with known application resource characteristics or integration patterns. This validation may involve checking if the requested endpoint is reachable, if the provided credentials are valid, and if the required communication protocol is supported. The system also verifies that the application resource is compatible with the infrastructure’s security policies and operational standards. Validation results are stored in content item database 150, where they can be referenced during subsequent operations. If pre-validation checks identify issues, the system notifies the resource consumer through interface 138 and provides guidance for resolving discrepancies. Well-formed and actionable requests proceed to the next stage.

In an embodiment, the system captures and logs metrics related to the request, such as processing time and the complexity of the requested connection configuration. These metrics are analyzed to optimize the request-handling process and improve the efficiency of the system. For example, recurring patterns in request attributes may lead to the creation of new templates or pre-built configurations. The logged data is also used to support system-level monitoring and reporting, providing insights into the frequency and types of requests being processed. These insights can inform administrative decisions, such as prioritizing certain integration workflows or identifying potential bottlenecks in the request pipeline. The system maintains records of request activity for operational transparency support.

In an embodiment, the system identifies a candidate set of connection configurations for accessing the connection to the application resource (Operation 202). The system queries content item database 150 to locate stored configurations 152 that match the parameters specified in the request. This process involves searching for configurations that are compatible with the target application resource’s endpoint, protocol, and security requirements. For example, if the resource consumer requests integration with an email server, the system identifies configurations that support SMTP or IMAP protocols. The query may also filter configurations based on specific project associations, ensuring that only relevant options are considered. In an embodiment, a match may be generated even if it does not meet requirements. For example, the closest matches may be presented. The system may indicate that the match does not meet requested criteria by presenting an icon, text, color scheme, or other user interface element that indicates the match is not a perfect match.

In an embodiment, the system applies advanced filtering criteria to refine the candidate set of connection configurations. These criteria may include metadata attributes, such as the configuration’s usage history, performance metrics, or creation date. For example, the system might prioritize configurations that have demonstrated popularity, high reliability, or low latency in past operations. Newer connections may also be prioritized. Additional filtering may exclude configurations that are deprecated or marked as inactive, ensuring that only current and viable options are presented. The filtering process is dynamic and adjusts to the context of the request, such as the specific needs of project A 134 or project B 136.

In an embodiment, the system ranks the candidate configurations based on their suitability for the resource consumer’s request. Ranking factors may include compatibility with the resource consumer’s preferred security protocols, alignment with organizational policies, or the ease of deployment within the existing infrastructure. For example, configurations that utilize widely accepted standards (e.g., OAuth 2.0) for authentication may be ranked higher. The ranking process leverages metadata stored alongside configurations 152 to evaluate the relative strengths of the options. Ranked results are stored temporarily in memory for subsequent operations. In an embodiment, if the system determines that no stored configurations meet the request criteria, it may invoke connection generation module 102 to create a new configuration. This new configuration is designed to satisfy the specific requirements outlined in the request, such as integrating with a previously unconnected application resource. Once created, the new configuration is stored in content item database 150, adding to the pool of available options for future requests.

In an embodiment, the system presents the candidate set of configurations for accessing the connection (Operation 203). The system displays the candidate configurations to the resource consumer through interface 138, enabling detailed evaluation and selection. The configurations are presented with key attributes, such as the associated application resource, communication protocol, and authentication method. For example, a configuration for accessing a cloud storage service might display its endpoint URL, supported data formats, and the expiration date of its credentials. The system organizes the candidate configurations into categories or groups to simplify the evaluation process. These categories may be based on different attributes, such as the type of application resource (e.g., database, API, or SaaS platform), security level, or previous usage within the same project. For example, configurations relevant to project A 134 might be grouped together for quick reference, while another group might highlight configurations optimized for project B 136.

In an embodiment, the system enriches the presentation with metadata that provides additional context about the configurations. Metadata attributes may include the connection’s creation date, recent usage statistics, and any performance issues logged during past operations. This information helps the resource consumer assess the reliability and compatibility of the configurations. For example, a connection with high throughput and low error rates may be more desirable for workflows requiring high data volume. Metadata is retrieved from content item database 150 and integrated into the display dynamically.

In an embodiment, the system enforces access control policies, so resource consumers only view configurations they are authorized to access. These policies are defined within project management system 130 and applied to the candidate set before presentation. For example, a resource consumer associated with project A 134 might only see configurations tied to that project, while configurations for project B 136 remain hidden. This access control mechanism safeguards sensitive connection configurations and prevents unauthorized usage. Notifications or error messages are displayed if a resource consumer attempts to view restricted configurations.

In an embodiment, the system receives a selection of a connection configuration from the candidate set of configurations (Operation 204). The selection is made by the resource consumer through interface 138 and transmitted to connection management system 100 for further processing. The system validates the selected configuration to confirm that it is available, compatible, and suitable for the intended use case. For example, the system checks if the configuration’s endpoint is still active and if the provided credentials remain valid. In an embodiment, the system records the selection and its associated metadata in content item database 150. This metadata includes numerous details, such as the resource consumer’s identity, the project (e.g., project A 134 or project B 136) that will use the connection, and the timestamp of the selection. This record serves as an auditable log of the decision-making process and provides traceability for troubleshooting or compliance purposes. The metadata also supports analytics, such as identifying frequently selected configurations or understanding selection trends.

In an embodiment, the system associates the selected configuration with the relevant project by updating project management system 130, so the connection is integrated into the operational context of the project, enabling workflows within project A 134 or project B 136 to utilize the connection. The system also verifies that the project has sufficient resources allocated to support the connection’s operation, such as processing power or network bandwidth. In an embodiment, the system provides real-time feedback to the resource consumer on the status of the selection. This feedback may include confirmation messages, additional details about the selected configuration, or error notifications if issues arise during validation. For example, if the credentials associated with the configuration have expired, the system prompts the resource consumer to update them before proceeding. The system confirms that the connection is fully operational and ready for deployment in the project environment.

In an embodiment, the system configures the resource consumer to use the selected connection configuration to access the connection (Operation 205). The system retrieves the selected configuration from content item database 150 and applies its parameters, such as endpoint details, protocol specifications, and authentication credentials. These parameters are used to establish communication between the resource consumer’s project (e.g., project A 134 or project B 136) and the target application resource. The system coordinates with input/output module 108 to handle the data exchange between the resource consumer’s project and the application resource. Input/output module 108 applies data transformation rules and routing logic specified in the connection configuration to verify compatibility between the two endpoints. For example, data sent from project A 134 might be transformed into a format required by the target application resource, while incoming data is converted back into a format suitable for the project.

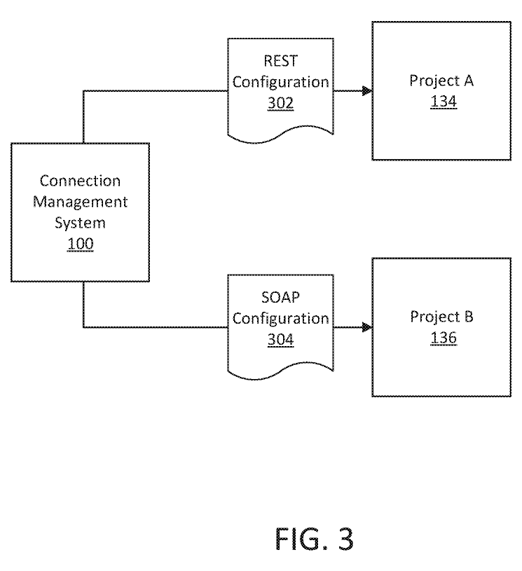

As an example, FIG. 3 illustrates a connection management system configuring two resource consumers in one or more embodiments. Connection management system 100 configures Project A 134 with REST configuration 302. Connection management system 100 sets up Project A 134 using REST configuration 302 by creating a set of web-based endpoints that allow easy communication between systems. These endpoints use simple HTTP methods like GET, POST, PUT, and DELETE to perform actions on resources, such as retrieving or updating data. Data is typically sent and received in lightweight formats like JSON, making it fast and easy to use. For example, to access user details, Project A could send a GET request to /users/123, and the system would return the information in JSON format.

Connection management system 100 configures Project B 136 with SOAP configuration 304 by defining a structured XML-based communication system. This setup relies on a WSDL (Web Services Description Language) file that specifies how requests and responses are formatted, ensuring precise and formal communication between systems. SOAP includes built-in security and error handling features, and all messages are wrapped in a SOAP envelope. For instance, to access user details, Project B sends an XML request to the SOAP service, and the service responds with an XML document containing the requested information. One or more operations illustrated in FIG. 3 may be modified, rearranged, or omitted. Accordingly, the particular sequence of operations illustrated in FIG. 2 should not be construed as limiting the scope of one or more embodiments.

In an embodiment, the system monitors the connection’s performance during operation through connection instance tracking module 110. Metrics, such as latency, throughput, and error rates, are logged in content item database 150 to provide visibility into the connection’s operational status. This information is accessible through interface 138, allowing the resource consumer to monitor and troubleshoot the connection as needed. The monitoring data also supports optimization efforts such as adjusting resource allocations to improve performance.

In an embodiment, the system updates project management system 130 to reflect the active deployment of the connection within the resource consumer’s project. The connection is accounted for in the project’s resource usage and access control policies. For example, additional processing resources might be allocated to project B 136 to support a high-volume connection. Real-time notifications are sent to the resource consumer through interface 138, providing updates on the connection’s status and readiness for use.

In an embodiment, the system receives a new request associated with a second resource consumer or project to establish a communication session between a resource consumer and the application resource. This request specifies the resource consumer’s intent to initiate a live data exchange or perform operations through the previously established connection configuration. The request may include identifiers for the resource consumer, the target application resource, and any additional session-specific parameters, such as required data transformation rules, session timeouts, or access scopes. The system parses this request and verifies that it includes sufficient detail to proceed with session establishment. The parsed information is temporarily stored to maintain context throughout the session setup process.

In an embodiment, the system validates the new request by cross-referencing the provided identifiers with records in the content item database. This validation confirms that the requested connection configuration remains active and accessible. The system also verifies that the resource consumer’s permissions align with the access requirements for the specified application resource. If validation succeeds, the system queues the session request for further processing. If validation fails, the system generates an error response with details about the mismatch, such as an expired identifier or insufficient access rights, and sends it back to the resource consumer for corrective action.

In an embodiment, the system establishes a communication session between the resource consumer and the application resource using the connection configuration identified by a reference identifier. This involves applying the parameters stored in the connection configuration, such as the endpoint, protocol type, and authentication credentials, to create an operational communication channel. The system initiates the session by contacting the application resource’s endpoint and performing the necessary handshake operations defined by the protocol. Once the handshake is successful, the system transitions the session into an active state, allowing data exchange to begin.

In an embodiment, the system configures the session to adhere to any additional session-specific parameters provided in the request. This configuration may include enabling encryption for secure data transfer, applying data transformation rules, and setting session limits, such as data throughput caps or timeouts. During the session, the system monitors its operational status, tracking various metrics, such as latency, error rates, and data volume. These metrics are logged for auditing and performance optimization purposes. If the session encounters issues, such as connection instability, the system may attempt automatic recovery actions to maintain continuity.

In an embodiment, at runtime, the system identifies the connection configuration using the reference to the connection configuration subsequent to receiving the second request. The reference acts as a unique identifier that links the runtime process to the specific connection configuration previously established or selected by the resource consumer. The system queries the stored configurations in the content item database to retrieve the parameters associated with the referenced configuration. These parameters typically include the endpoint address, protocol type, authentication credentials, and any metadata required to establish the communication session.

In an embodiment, the system validates the retrieved connection configuration to confirm its applicability and availability at runtime. This validation step includes ensuring the endpoint is active, verifying the credentials’ validity, and checking that the configuration complies with any runtime-specific policies, such as data security or usage constraints. The system also verifies that the resource consumer has the necessary permissions to use the referenced configuration in the current runtime context. If the validation is successful, the system proceeds with using the connection configuration to establish a communication session with the application resource. If any issues are detected, such as an inactive endpoint or expired credentials, the system generates an error response and logs the issue for administrative review.

In an embodiment, the system receives additional requests associated with different projects to use the same connection. These requests may specify project-specific details, such as the workflows or operations to be executed, along with references to the shared connection. The system processes requests by extracting relevant project identifiers and validating the request against the permissions and access policies associated with the connection. For example, project A 134 and project B 136 may both request access to the same connection for an API integration, but each project may have unique workflow requirements or resource constraints.

In an embodiment, the system verifies that the shared connection can handle concurrent usage by maintaining operational independence between projects. The system isolates the workflows of the projects, preventing data or operations from one project from interfering with those of another. This is achieved through session-level configurations that customize the use of the connection for projects while relying on the same underlying connection configuration. The system applies any necessary data transformation or routing rules based on the context of the project making the request. The system tracks the utilization of the shared connection by logging the additional requests and their associated project identifiers in the content item database. These logs include details, such as the time of the request, the project utilizing the connection, and any specific parameters applied during the session. This information is used to monitor the overall load on the connection and dynamically update the configuration, so its performance remains stable under multiple simultaneous requests. The tracking data also supports auditing and optimization efforts.

In an embodiment, the system dynamically adjusts resource allocations or prioritization to accommodate the additional requests while preserving the performance of the shared connection. For example, if project A 134 and project B 136 generate high data throughput simultaneously, the system may balance the network bandwidth allocated to each project for simultaneous access to the connection and prevention performance degradation. The system provides real-time feedback to each project through interface 138, confirming the successful handling of their requests and highlighting any adjustments made to accommodate the shared usage.

In an embodiment, the system updates the connection configuration, resulting in changes that affect other projects currently using the connection. The update process begins when a user, resource consumer, or administrator modifies attributes of the configuration, such as endpoint details, authentication credentials, or data transformation rules. These updates are recorded in the content item database, replacing the previous configuration while maintaining a version history for auditing purposes. The system identifies the projects currently associated with the connection and assesses the impact of the update on project workflows. For example, if the endpoint address is updated, the system verifies that the new endpoint is accessible and compatible with the operations of project A 134 and project B 136. This assessment is used to verify that the updated configuration does not disrupt existing workflows or introduce compatibility issues. The system may also test the updated connection in a staging environment before applying it to live workflows.

In an embodiment, the system propagates the updated connection configuration to the affected projects in real time or as part of a scheduled update cycle. The system applies the new configuration parameters to each project’s active sessions, ensuring that data exchange and operations align with the revised settings. For example, updated credentials are immediately applied to active sessions to maintain uninterrupted access to the target application resource. The system provides notifications through interface 138 to inform resource consumers of the update and its successful implementation.

In an embodiment, the system monitors the performance and status of the connection following the update to ensure stability and compliance. Connection instance tracking module 110 logs metrics, such as connection uptime, error rates, and data throughput for each project of a set of projects, using the updated connection. These metrics are analyzed to detect any issues introduced by the update and optimize the connection’s performance. If any problems are identified, the system may roll back the update or provide guidance for additional corrective actions, ensuring that the shared connection remains reliable and functional for associated projects.

In an embodiment, when a connection configuration is updated, the reference to the connection configuration may remain unchanged or be replaced with a new reference, depending on the nature of the update. For minor updates, such as changes to non-critical parameters, like metadata or optional fields, the system retains the existing reference, ensuring that the connection remains accessible to associated projects without interruption. However, for significant updates, such as changes to the endpoint or authentication credentials, the system may generate a new reference to reflect the revised configuration. If a new reference is assigned, the system identifies projects, such as project A 134 and project B 136, that are associated with the previous reference and automatically updates their connection configurations to use the new reference. Workflows within these projects remain functional and aligned with the updated connection, maintaining consistency across projects that share the connection. The system logs these changes and provides notifications to resource consumers, ensuring transparency and traceability for the update process.

In an embodiment, a user who is utilizing a connection set up by another entity in their project may need to override certain settings to tailor the connection to their specific workflow requirements. When the user selects the connection for use in their project, such as project A 134, the system provides an interface through which the user can modify settings, like data transformation rules, timeout thresholds, or retry mechanisms. These overridden settings apply only within the scope of the user’s project, ensuring that the adjustments do not affect the connection as used by other projects or resource consumers. The system enforces restrictions on which settings can be overridden based on rules defined by the entity that created the connection. For example, the creator may designate critical settings, such as endpoint addresses or authentication credentials, as non-overridable to maintain security and compatibility across projects using the connection. These restrictions are stored as metadata within the connection configuration and are applied dynamically when a user attempts to make changes. For example, if a user tries to override a restricted setting, the system generates an error message and provides guidance on acceptable modifications.

In an embodiment, the system provides a clear distinction between overridable and non-overridable settings within the user interface. Overridable settings are presented as editable fields, while non-overridable settings are displayed as read-only attributes. For example, the user may be able to adjust data format mappings or logging preferences but may see endpoint details grayed out to indicate they cannot be changed. This distinction enhances usability by clarifying the boundaries of permissible modifications. Additionally, the system may include explanatory notes or tooltips that describe why certain settings are non-overridable, reinforcing the rationale behind the restrictions.

In an embodiment, when a user overrides settings for a connection in their project, the system records these overrides as project-specific metadata in content item database 150. This metadata includes various details, such as the overridden settings, the user who made the changes, and the timestamp of the modifications. Overrides are applied only within the context of the user’s project, preventing unintended side effects on other projects that share the connection. The system enables the connection’s creator or administrator to review and manage the override permissions for settings, allowing granular control over what can and cannot be customized by other users. For example, a connection creator may grant permission to override retry intervals for one project while restricting access to authentication settings for users. These permissions can be updated dynamically, allowing the creator to adjust override capabilities as organizational policies or technical requirements evolve. The system communicates these updates to users through notifications in interface 138, ensuring that stakeholders are aware of changes to their ability to customize shared connections. This balance of flexibility and control allows shared connections to meet diverse requirements while maintaining a secure and cohesive integration environment.

In an embodiment, a user searching for a connection to use in their project interacts with the system to locate a suitable connection based on specific criteria such as connection type. For example, the user might specify a type like “Salesforce connection” to integrate their project with a Salesforce platform. The system processes this query by referencing metadata stored in content item database 150. Database 150 categorizes connections by different attributes, such as type, target application resource, and supported operations. The user’s search parameters are applied to filter the available connections, narrowing the results to those that align with the specified type. In an embodiment, the system executes the query dynamically, retrieving a list of connections that meet the search criteria and presenting them through interface 138. The connections in the results are displayed with key attributes, such as the associated application resource, the communication protocol, and relevant metadata, like performance history or access permissions. For example, if the query returns multiple Salesforce connections, the user might see details about the environment (e.g., production or sandbox), the authentication method used (e.g., OAuth), and recent usage metrics.

In an embodiment, after selecting a connection, the user can add it to their project, such as project A 134, directly through the interface. The selected connection is accessible to the user. The system validates their permissions, thereby verifying that the connection aligns with the operational context of the project. If the user does not have access to any of the connections returned by the query, the system provides feedback indicating the issue and may suggest steps to request access or modify the query criteria.

In an embodiment, the query executed by the system to locate connections may also incorporate characteristics of the user’s project to refine the results further. For example, the query may take into account project-specific attributes, such as the geographic region of operation, the data compliance requirements, or the type of workflows the project supports. If the project, such as project A 134, operates in a region with stringent data residency regulations, the system may prioritize connections that align with those restrictions such as endpoints hosted in approved locations. Similarly, if the project requires high-throughput data exchanges, the system may include performance metrics as a filter to identify connections with proven reliability and scalability. The returned connections are the correct type and tailored to meet the specific operational and compliance needs of the project. Users can use contextual filtering to identify connections that best suit their project requirements.

In an embodiment, the query executed by the system to search for connections may also incorporate permissions associated with the resource consumer initiating the search. Permissions are used to filter the results, so the returned connections are accessible to the user based on their role, project associations, or organizational policies. For example, a resource consumer with access limited to specific projects or application resources will only see connections that align with their access rights. If a user searching for a Salesforce connection does not have the necessary permissions to view connections tied to a production environment, the system will exclude those connections from the results. Integrating permissions into the query safeguards sensitive connection configurations, so users are only presented with connections they are authorized to use.

In an embodiment, creating a connection begins when a user initiates the process to define a new connection that is not necessarily tied to a specific project. This flexibility allows the user to establish a reusable resource that can later be assigned to one or more projects as needed. During the creation process, the user specifies key parameters for the connection, such as the target application resource, the endpoint address, and the authentication method. For example, if the connection is intended for integration with a Salesforce environment, the user might define the API endpoint, select OAuth as the authentication mechanism, and configure client credentials. These parameters form the foundation of the connection and determine its operational characteristics.

In an embodiment, the user has the option to mark the newly created connection as sharable or non-sharable during the creation process. A sharable connection is made available for use by other resource consumers or projects, subject to access control policies defined by the user or the organization. By contrast, a non-sharable connection remains private and is only accessible to the creator or their designated projects. This distinction allows the user to control the visibility and utilization of the connection, enabling tailored access to suit specific workflows or security requirements. The sharable status is stored as metadata within the connection configuration and is enforced by the system during subsequent queries or assignment operations.

In an embodiment, once the connection parameters are defined, the system validates the configuration to verify its correctness and operability. This validation may include testing the endpoint for reachability, verifying the authentication credentials, and confirming compatibility with the target application resource. Any errors or inconsistencies detected during validation are communicated to the user for correction. Upon successful validation, the system stores the connection configuration in a searchable database such as content item database 150. In an embodiment, the connection is indexed in the database with searchable metadata attributes, including its type, associated application resource, creation date, sharable status, and any custom tags added by the user. This metadata facilitates dynamic queries and filtering, enabling resource consumers to locate the connection based on various criteria, such as functionality, target resource, or access permissions. The stored connection becomes a robust asset within the system, ready to be assigned to projects or used directly in workflows. The separating of the creation of the connection from its immediate assignment promotes modularity and reuse.

In an embodiment, the owner of a connection initiates an audit request to obtain a comprehensive list of resources associated with the connection. The audit request is processed by the system to retrieve metadata and association details stored in content item database 150. These details include information about the projects, such as project A 134 or project B 136, and other entities that are currently using or have been granted access to the connection. The owner uses this audit request to ensure that the connection is being utilized as intended and to verify compliance with organizational policies or access restrictions. The system processes the audit request by querying the database for associations linked to the connection, including active and historical usage records. The system retrieves information about the connection’s assignments, such as the identity of the projects or entities that have used the connection, the timeframes of usage, and any specific operational parameters applied during their access. For example, the response to the audit request might indicate that project B 136 is actively using the connection to integrate with an external CRM system, while another entity is using the connection for a data synchronization workflow.

In an embodiment, the system generates a detailed response to the audit request. The audit request is delivered to the connection owner through interface 138 or another designated reporting mechanism. The response includes structured data that identifies the associated projects, such as their names, resource consumers involved, and any custom configurations or overrides applied during their use of the connection. Additionally, the response may include metadata, such as usage metrics, access timestamps, and the security roles associated with each project or entity. The response to the audit request may highlight instances where another entity or project is associated with the connection, allowing the owner to assess if such associations are authorized and appropriate. If the response reveals unexpected or unauthorized usage, the connection owner can take corrective actions, such as revoking access, updating permissions, or modifying the connection configuration. The audit functionality provides transparency into the connection’s utilization, supporting governance, compliance, and optimization of shared resources across the system.

In an embodiment, the system detects a connection failure indicator associated with the first project, such as project A 134, wherein the connection failure indicator specifies that one or more resources within the first project are unable to access the application resource associated with the first connection configuration. The detection occurs through real-time monitoring of connection performance metrics, such as failed authentication attempts, endpoint timeouts, or abnormal latency patterns. For example, if a connection configured to integrate project A 134 with a third-party application encounters an unreachable endpoint, the system identifies this condition as a connection failure. The connection failure indicator is logged and associated with the first project, ensuring that the issue is localized for diagnostic and reporting purposes.

In an embodiment, responsive to detecting the connection failure indicator, the system generates one or more inherited connection failure indicators corresponding to projects, other than the first project, that are configured to use the same connection configuration. These inherited indicators signal that the connection failure associated with project A 134 may also affect resources within other projects, such as project B 136, that rely on the same connection configuration to access the application resource. For example, if project B 136 shares the same authentication credentials or endpoint as project A 134, the inherited connection failure indicator alerts the system that project B 136 might experience similar access issues without requiring a new connection attempt to confirm the failure.

In an embodiment, the inherited connection failure indicators provide detailed information about the potential impact on resources associated with other projects. These indicators specify that resources in a different project than the one that originally experienced the failure are unable to access the same application resource. The system generates these indicators by extrapolating the failure conditions identified in project A 134 and applying them to projects sharing the same connection configuration. This preemptive notification mechanism prevents unnecessary connection attempts by other projects.

In an embodiment, the step of generating inherited connection failure indicators occurs after the initial detection of the connection failure indicator for the first project but before any subsequent connection attempts are made by the resources associated with the other projects. By propagating the failure condition in this sequence, the system verifies that inherited connection failure indicators are distributed proactively, minimizing disruptions across the shared integration environment. The system updates content item database 150 to reflect the inherited indicators and provides notifications through interface 138 to inform resource consumers and administrators about the potential impact on their respective projects.

In an embodiment, users of connections are granted access to specific metadata about connections based on their access privileges, ensuring that sensitive information is protected while providing necessary operational details. For example, a user with standard access privileges may view general metadata, such as the connection type, the application resource it interacts with, and performance statistics, like uptime and latency. This metadata supports effective use of the connection within a project while restricting access to more sensitive details. The system dynamically applies access control policies during metadata retrieval, filtering out information, such as authentication credentials, security configurations, or project-specific overrides, unless explicitly authorized for the user.

In an embodiment, the granularity of metadata access is determined by roles, organizational policies, and project associations defined within the system. For example, an administrator may have full access to metadata, including endpoint addresses, detailed usage logs, and historical configuration changes, while a standard user is limited to high-level operational insights. These policies ensure that users can access the information required to perform their roles without exposing sensitive connection details unnecessarily. The system enforces these restrictions during queries and metadata presentation with unauthorized fields either omitted entirely or marked as inaccessible.

### COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

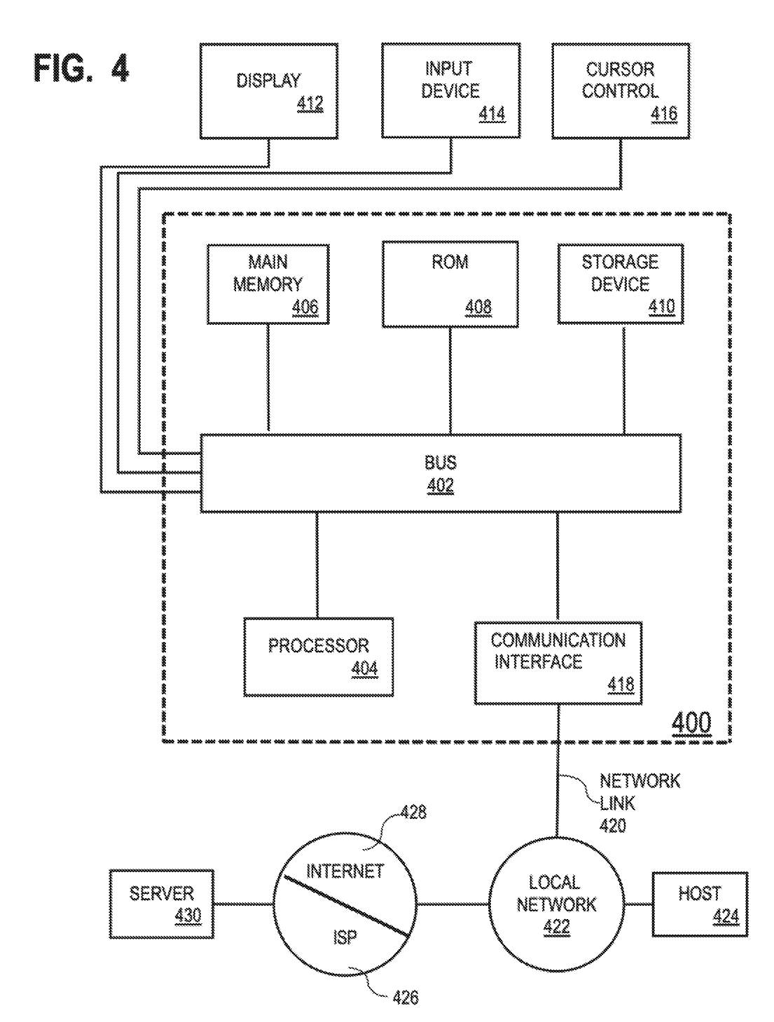

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, causes performance of operations comprising:
receiving a first request for a connection configuration for a first resource consumer to access a first connection to an application resource;
identifying a candidate set of one or more connection configurations for accessing the first connection to the application resource, where the candidate set of one or more connection configurations are stored remotely from the first resource consumer;
presenting the candidate set of one or more connection configurations for accessing the first connection to the application resource;
receiving a selection of a particular connection configuration from the candidate set of one or more connection configurations;
configuring the first resource consumer to use the particular connection configuration to access the first connection to the application resource by storing a reference to the particular connection configuration in association with the first resource consumer.

2. The one or more non-transitory computer readable media of claim 1, wherein the operations further comprise:
receiving a second request to establish a communication session between the first resource consumer and the application resource;
establishing the communication session between the first resource consumer and the application resource using the particular connection configuration accessible via the reference.

3. The one or more non-transitory computer readable media of claim 2, wherein the operations further comprise:
determining, at runtime and subsequent to receiving the second request, the particular connection configuration via the reference to the particular connection configuration.

4. The one or more non-transitory computer readable media of claim 2, wherein the operations further comprise:
receiving a third request to establish a communication session between the first resource consumer and the application resource;
establishing the communication session between the first resource consumer and the application resource using an updated connection configuration accessible via the reference.

5. The one or more non-transitory computer readable media of claim 1, wherein configuring the first resource consumer to use the particular connection configuration comprises configuring an override operation that overrides (a) a first connection configuration stored in relation to the first resource consumer with (b) the particular connection configuration to access the connection to the application resource.

6. The one or more non-transitory computer-readable media of claim 1, wherein identifying a candidate set of one or more connection configurations comprises executing a query constructed to retrieve one or more connection type indicators, wherein the candidate set of one or more connection configurations are based on the one or more connection type indicators.

7. The one or more non-transitory computer readable media of claim 6, wherein the first request comprises a connection type, wherein the query defines the connection type and wherein the candidate set of one or more connection configurations correspond to the connection type.

8. The one or more non-transitory computer readable media of claim 6, wherein the first request comprises one or more characteristics associated with the resource consumer, wherein the query defines the one or more characteristics and wherein the candidate set of one or more connection configurations are available to resource consumers with the one or more characteristics.

9. The one or more non-transitory computer readable media of claim 6, wherein the query defines permissions associated with the first resource consumer and wherein the candidate set of one or more connection configurations include connection configurations that are accessible based on the permissions.

10. The one or more non-transitory computer readable media of claim 6, wherein the operations further comprise:
prior to receiving the first request:
receiving an input (a) defining the particular connection configuration and (b) indicating that the particular connection configuration is a shareable connection configuration;
based on the input, storing the particular connection configuration in a searchable database;
wherein the query identifies the particular connection configuration, from the searchable database, to include in the candidate set of one or more connection configurations.

11. The one or more non-transitory computer-readable media of claim 1, wherein a connection is a coupling between a connection configuration and an application resource that can be accessed via the connection configuration.

12. The one or more non-transitory computer-readable media of claim 11, further comprising:
receiving a second request for a connection configuration for a second resource consumer to access an application resource;
identifying a candidate set of one or more connection configurations for accessing the first connection to the application resource that includes the particular connection configuration;
receiving a selection of the particular connection configuration from the candidate set of one or more connection configurations;
configuring the second resource consumer to use the particular connection configuration to access the first connection to the application resource by storing a reference to the particular connection configuration in association with the second resource consumer.

13. The one or more non-transitory computer readable media of claim 12, wherein the first resource consumer is a first project, and the second resource consumer is a second project, wherein each project comprises an isolated environment for managing workflows, allocating resources, and facilitating interactions with one or more connections, wherein each project corresponds to a specific set of parameters that define resource allocations.

14. The one or more non-transitory computer readable media of claim 13, further comprising:
establishing a first entity as an owner of the first connection;
establishing the first entity as an owner of the first project;
establishing the second entity as an owner of the second project;
receiving an audit request from the first entity, wherein the audit request is a request for a list of resources associated with the first connection;
responding to the first entity with a response to the audit request, wherein the response indicates that the second entity or the second project are associated with the first connection.

15. The one or more non-transitory computer readable media of claim 13, further comprising:
detecting a connection failure indicator associated with the first project, wherein the connection failure indicator indicates that one or more resources associated with the first project are unable to access the application resource associated with the first connection configuration;
responsive to detecting the connection failure indicator, generating one or more inherited connection failure indicators corresponding to one or more projects that are configured to use the first connection configuration to access the application resource;
wherein inherited connection failure indicators indicate that one or more resources associated with a different project than the corresponding project are unable to access the application resource associated with the first connection configuration;
wherein the step of generating one or more inherited connection failure indicators occurs after the generation of the connection failure indicator and before a connection attempt is made by a resource associated with the one or more projects corresponding to the inherited connection failure indicator.

16. The one or more non-transitory computer readable media of claim 12, further comprising:
configuring the first resource consumer to use the particular connection configuration to access the first connection to the application resource using a REST connection; and
configuring the second resource consumer to use the particular connection configuration to access the first connection to the application resource using a SOAP connection.

17. The one or more non-transitory computer readable media of claim 1, further comprising:
receiving a connection update request associated with a first entity;
identifying permissions associated with the first entity;
based at least in part on the permissions associated with the first entity, performing a connection update operation to change the configuration associated with the connection.

18. The one or more non-transitory computer readable media of claim 1, further comprising:
presenting to a first user, within a first user interface for a first project that uses the first connection, first metadata and second metadata associated with the first connection;
presenting to a second user, within a second user interface for a second project that uses the first connection, the first metadata associated with the first connection;
withholding, from the second user, the second metadata associated with the first connection.

19. A method, which when executed by one or more hardware processors, causes performance of operations comprising:
receiving a first request for a connection configuration for a first resource consumer to access a first connection to an application resource;
identifying a candidate set of one or more connection configurations for accessing the first connection to the application resource, where the candidate set of one or more connection configurations are stored remotely from the first resource consumer;
presenting the candidate set of one or more connection configurations for accessing the first connection to the application resource;
receiving a selection of a particular connection configuration from the candidate set of one or more connection configurations;
configuring the first resource consumer to use the particular connection configuration to access the first connection to the application resource by storing a reference to the particular connection configuration in association with the first resource consumer;
receiving a second request for a connection configuration for a second resource consumer to access an application resource;
identifying a candidate set of one or more connection configurations for accessing the first connection to the application resource that includes the particular connection configuration;
receiving a selection of the particular connection configuration from the candidate set of one or more connection configurations; and
configuring the second resource consumer to use the particular connection configuration to access the first connection to the application resource by storing a reference to the particular connection configuration in association with the second resource consumer.

20. A system comprising:
at least one device including a hardware processor;
the system being configured to perform operations comprising:
receiving a first request for a connection configuration for a first resource consumer to access a first connection to an application resource;
identifying a candidate set of one or more connection configurations for accessing the first connection to the application resource, where the candidate set of one or more connection configurations are stored remotely from the first resource consumer;
presenting the candidate set of one or more connection configurations for accessing the first connection to the application resource;
receiving a selection of a particular connection configuration from the candidate set of one or more connection configurations;
configuring the first resource consumer to use the particular connection configuration to access the first connection to the application resource by storing a reference to the particular connection configuration in association with the first resource consumer.
